(19) United States
(12) Patent Application Publication
(10) Pub. No.: US 2012/0111241 A1
(43) Pub. Date: May 10, 2012

(54) TABLE WITH INTERCHANGEABLE TOP PIECE

(76) Inventor: Robyn Karp, New York, NY (US)

(21) Appl. No.: 12/943,735

(22) Filed: Nov. 10, 2010

(51) Int. Cl. A47B 13/08; B23P 19/00; A47B 13/02

(52) U.S. Cl. 108/157.17; 108/161; 29/426.1

(57) ABSTRACT

A table with a removable and interchangeable top piece. The table may have a base that has a receiving surface, an underside surface, and at least one sidewall coupled to the receiving surface. A cavity may be defined at least in part by the receiving surface and the at least one sidewall. A bore may extend through the receiving surface and the underside surface. The bore may have a first diameter at the receiving surface and a second diameter at the underside surface. A piston having a lifting portion may be positionable at least partially within the bore. The piston may be movable between a first position and a second position when positioned at least partially within the bore. A top piece may be dimensioned to be at least partially received by the cavity.

### BACKGROUND

Tables are used for a variety of uses. In a restaurant setting, for example, tables are utilized mainly for functional uses. In home decor, tables may be chosen by a homeowner or designer based on their style, coloring, or other aesthetic qualities.

### BRIEF DESCRIPTION OF THE DRAWINGS

The present invention will be more readily understood from a detailed description of example embodiments taken in conjunction with the following figures:

FIGS. 1 and 1A are exploded views of a table in accordance with one non-limiting embodiment.

FIG. 2 is a elevational view of a table in accordance with one non-limiting embodiment.

FIG. 3 is a cross-sectional view of FIG. 2 taken along line 3-3.

FIG. 3A is a cross-sectional view of a table in accordance with one non-limiting embodiment.

FIGS. 4A, 4B, and 4C illustrate an operational progression of a table in accordance with one non-limiting embodiment.

FIG. 5 is an enlarged cross-sectional view of FIG. 4B.

FIG. 6 is an exploded prospective view of a top piece in accordance with one non-limiting embodiment.

FIG. 7 is a partial cross-sectional elevational view of a table in accordance with one non-limiting embodiment.

FIGS. 8 through 12 illustrate tables with interchangeable top pieces in accordance with various embodiments.

FIG. 13A is a perspective view of a piston in accordance with one non-limiting embodiment.

FIG. 13B is a bore configure to receive the piston of FIG. 13A.

FIG. 14A shows a piston in a first position in accordance with non-limiting embodiment.

FIG. 14B shows the piston of 14A in a second position in accordance with one non-limiting embodiment.

FIG. 15A shows a threaded piston in accordance with one non-limiting embodiment.

FIG. 15B shows a bore configure to receive the piston of 15A in accordance with one non-limiting embodiment.

FIG. 16A is an exploded view of a table assembly in accordance with one non-limiting embodiment.

Corresponding reference characters indicate corresponding parts throughout the several views. The exemplifications set out herein illustrate various embodiments and such exemplifications are not to be construed as limiting the scope of the invention in any manner.

### DETAILED DESCRIPTION

Various embodiments are directed to apparatuses, systems, and methods for a table with an interchangeable top piece. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment,” or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation.

In accordance with various embodiments, a table is disclosed having an interchangeable top piece. In some embodiments the top piece may have a first design on a first surface and a second design on a second surface. As the user wishes to change the aesthetics, for example, of the table, the user may optionally remove the interchangeable top piece and flip the top piece to reveal the second design. Alternatively, the user may wish to remove the interchangeable top piece and replaced it with a second interchangeable top piece. In any event, when the top piece is inserted into the table it may create a table that appears to be a finished table to an observer. A disassembly device, such as a piston, may be used by the user to assist in removing the interchangeable top from the table. In some embodiments, the piston may be configured such that it is difficult for a child, or other unwanted user, from operating the piston.

In accordance with various embodiments, a table apparatus may have a base. The base may have a receiving surface and underside surface and at least one sidewall coupled to the receiving surface. The base may also have a cavity that is defined at least in part by the receiving surface and the at least one sidewall. The base may also have a bore extending through the receiving surface and the underside surface. The bore may have a first diameter at the receiving surface and a second diameter at the underside surface. The table apparatus may also have a piston having a lifting portion, where the piston is positionable at least partially within the bore. The piston may be moveable between a first position and a second position. The table apparatus may also have a top piece dimensioned to be at least partially received by the cavity. The top piece may have a top surface and a bottom surface, where the piston does not lift the top piece out of the cavity when the piston is in the first position and the lifting portion of the piston contacts the bottom surface of the top piece and lifts the top piece at least partially out of the cavity in the second position. The table apparatus may also have at least one leg extending from the base.

In accordance with various embodiments, a table apparatus may have a base. The base may have a receiving surface, an underside surface, and at least one sidewall coupled to the receiving surface, the base may also have a cavity that is defined at least in part by the receiving surface and the at least one sidewall. The cavity may be configured to receive a top piece. The base may also have a bore that extends through the receiving surface and the underside surface. The base may also have a piston that comprises a lifting portion. The piston may be positionable at least partially within the bore and moveable between a first position and a second position. The table apparatus may also have at least one leg extending from the base.

In accordance with various embodiments, a method of using a table includes inserting a top piece into a cavity of a base with a first surface of the top piece exposed. The base may have a bore extending from an underside of the base into the cavity and a piston positioned within the bore and supported by the base. The method may also include advancing the piston at least partially through the bore and contacting a second surface of the top piece with the piston. The method may also include lifting the top piece from the cavity and removing the top piece from the cavity. The method may further include inserting the top piece into the cavity of the base with the second surface exposed.

In accordance with various embodiments, a method of manufacturing a table includes forming a base. The base may have a receiving surface, an underside surface, and at least one sidewall coupled to the receiving surface. The method may also include forming at least one leg attachable to the base. The method may also include forming a cavity defined at least in part by the receiving surface and at least one sidewall of the base. The method may also include forming a bore extending through the receiving surface and the underside surface and positioning a piston at least partially into the bore. The piston may have a lifting portion and the piston may be moveable between a first position and a second position. The method may also include positioning a top piece dimensioned to be at least partially received into the cavity. The top piece may have a top surface and a bottom surface and the bottom surface may be positioned to contact the piston during translation of the piston through the bore.

In accordance with various embodiments a table apparatus have a base. The base may have a receiving surface, an underside surface, and at least one sidewall coupled to the receiving surface. The base may also have a cavity defined at least in part by the receiving surface and the at least one sidewall and a bore extending through the receiving surface and the underside surface. The table apparatus may also have a top piece dimensioned to be at least partially received by the cavity, the top piece having a top surface and a bottom surface, the top piece moveable between a recessed position and a dislodged position. At least one leg may extend from base.

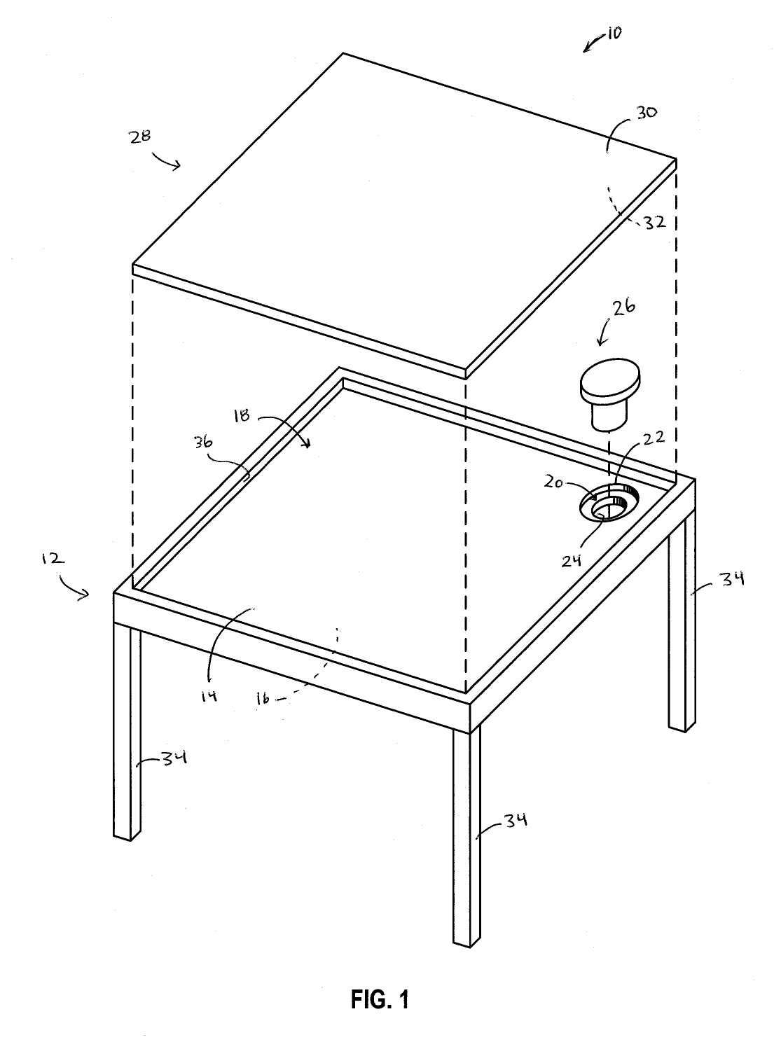

FIG. 1 is an exploded perspective view of a table 10 in accordance with one embodiment. The table 10 may comprise a base 12 from which at least one leg 34 extends. As illustrated, the table 10 comprises four legs 34 attached to the base 12. The legs 34 may be attached to the base 12 using any suitable attachment technique, such as screws, brackets, mortise and tenon, or dowel pins, for example. The legs 34 may be any suitable material, such as wood, plastic, or metal, for example. While FIG. 1 illustrates the legs 34 attached to the base, this disclosure is not so limited. In some embodiments, for example, the legs 34 may be integrally formed with base 12, such as during an injection molding process. The base 12 may comprise receiving surface 14 and an underside surface 16. The base 12 may also comprise a sidewall 36 that may generally surround the receiving surface 14. A cavity 18 may be defined at least partially by the sidewall 36 and the receiving surface 14. A top piece 28 may be dimensioned to be at least partially received by the cavity 18. The top piece 28 may have a top surface 30 and a bottom surface 32. An edge 38 may connect the top surface 30 to the bottom surface 32. The table 10 may also comprise a piston 26 that is insertable into a bore 20. The bore 20 may be positioned through the receiving surface 14 and the underside surface 16. At the receiving surface 14, the bore 20 may have a first diameter 22. At the underside surface 16, the bore 20 may have a second diameter 24. When the top piece 28 is inserted into the cavity 18 of the table 10, the piston 26 may be completely obscured from view when viewing the top surface 30. As discussed in more detail below, at least one of the top surface 30 and the bottom surface 32 may comprise graphics that are displayed to an observer.

FIG. 1A is an exploded perspective view of the table 10 in accordance with another embodiment. In this embodiment, instead of using piston 26 (FIG. 1), the user may use contact the bottom surface 32 of the top piece 28 using their fingers via the bore 20′. In other words, in some embodiments, the user may push the top piece 28 out of the cavity 18 by reaching underneath the base 12 and accessing the top piece 28 via the bore 20′. By pressing up on the bottom surface 32 of the top piece 28, the user will be able to move the top piece 28 from a recessed position to a dislodged position and remove the top piece 28 from the base 12. The bore 20′ may have a different size or configuration based on the application of the table 10. For example, if the table 10 is relatively small, and the top piece 28 is relatively light, a relatively small bore 20′ may be used which is dimensioned to receive one or two fingers of the user. In one embodiment, for example, the bore 20′ has a cross sectional area of about 3 inches. If the table 10 is relatively large, and/or the top piece 28 is relatively heavy, the bore 20′ may have a larger cross sectional area in order to accommodate the user's whole hand, for example. In one embodiment, for example, the bore 20′ has a cross sectional area of about 30 inches.

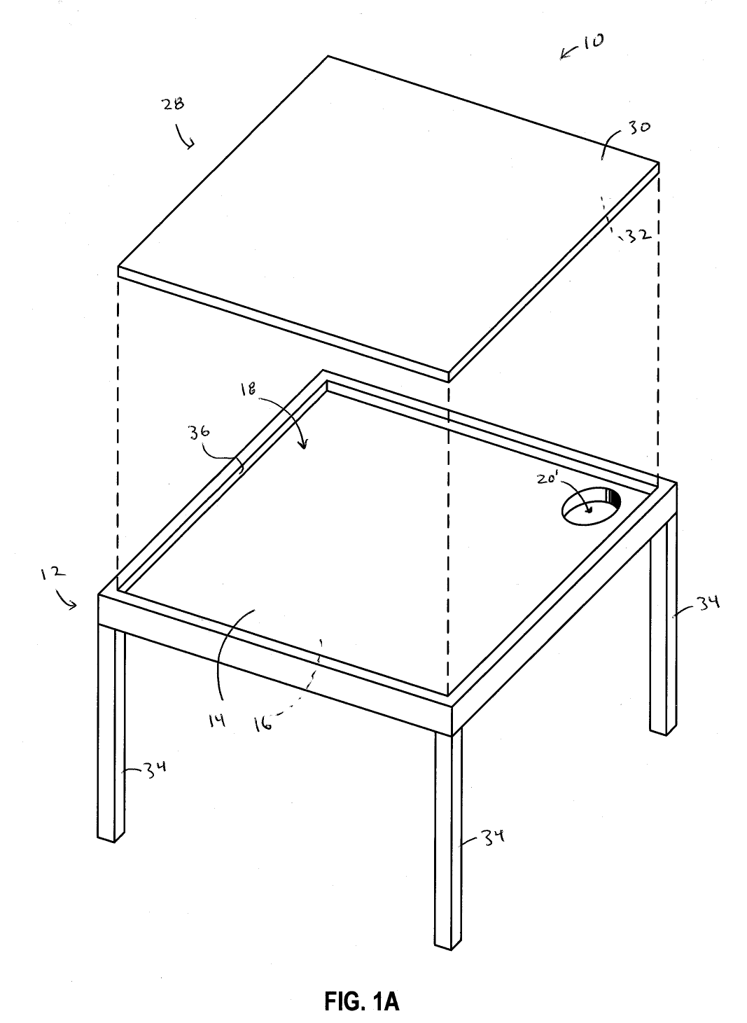

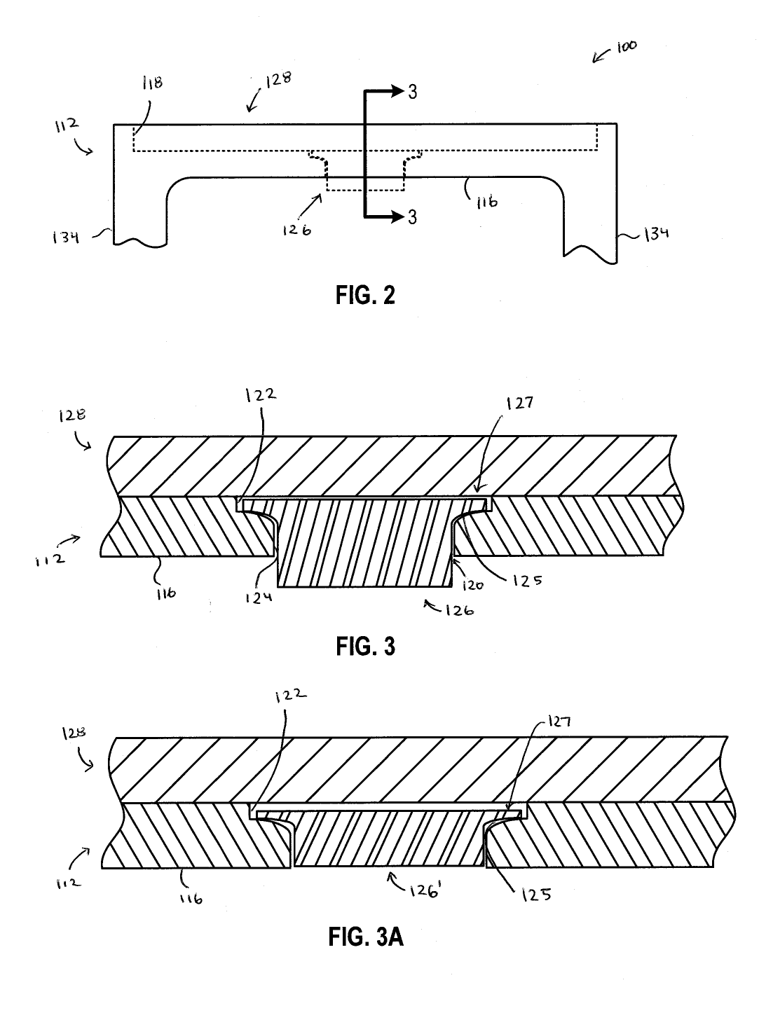

FIG. 2 is a side view of a table 100 in accordance with one non-limiting embodiment. The table 100 is illustrated with the top piece 128 inserted into the cavity 118 of the base 112. In the illustrated embodiment, the table 100 comprises a piston 126 that is centrally positioned in the table 100. As is to be appreciated, however, the piston 126 may be positioned in any suitable location within the table 100. Furthermore, while the table 100 is illustrated with a plurality of legs 134, in some embodiments the table 100 may only have one leg, for example.

FIG. 3 is a cross-sectional view of the table 100 taken along line 3-3. In this embodiment the piston 126 extends beyond the underside surface 116 of the base 112 such that it can be easily manipulated by the user. As illustrated in FIG. 3A, however, in some embodiments the piston may not extend beyond the underside surface 116. In FIG. 3A, the piston 126′ does not extend beyond the underside surface 116. Referring again to FIG. 3, the piston 126 is positioned within a bore 120 and is supported by the base 112. In this embodiment, the bore is circular and has multiple diameters. As is to be appreciated, the bore 120 may have any suitable cross-sectional shape that may be similar or dissimilar to the cross-sectional shape of the piston 126. As illustrated, the bore 120 has a first diameter 122 and a second diameter 124. The piston 126 has a flange 127 that has an outer diameter that is greater to the second diameter 124. Furthermore, the bore 120 transitions from the first diameter 122 to the second diameter 124 to create a shoulder 125. The flange 127 of the piston 126 sits on the shoulder 125. In this position, the top piece 128 may be inserted into the cavity 118 of the table 100 as illustrated in FIG. 2.

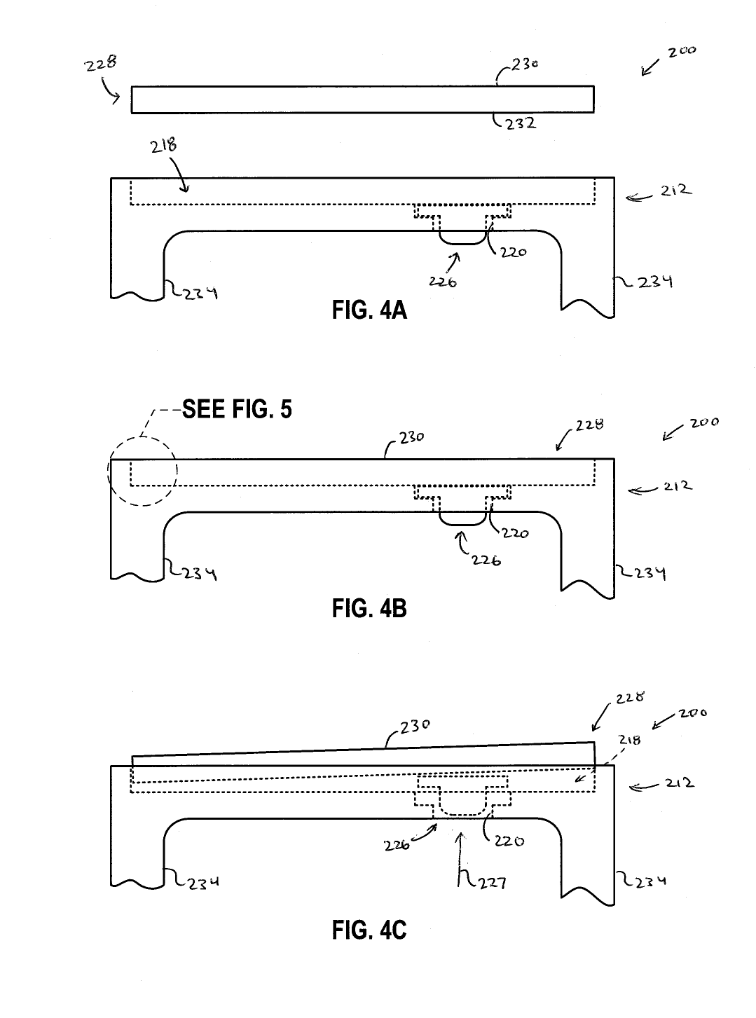

FIGS. 4A, 4B, and 4C illustrate the operational progression of a table 200 in accordance with one non-limiting embodiment. Referring first to FIG. 4A, a base 212 comprises a cavity 218 that is dimensioned to receive a top piece 228. The top piece 228 comprises a top surface 230 and a bottom surface 232. As shown in FIG. 4A, legs 234 extend from the base 212. The length of the legs 234 may be any suitable length as determined by the function of the table. For example, a table for use with small children may have shorter legs then a table for use in a restaurant, for example. While the legs 234 in FIGS. 4A, 4B, and 4C are integral with the base 212, it is to be appreciated that in some embodiments, the legs 234 may be separate components that are attached to the base 212. The table 200 comprises a piston 226 that is positioned within a bore 220 of the base 212. As illustrated, the piston 226 may comprise a beveled portion that mates with a beveled portion of the base 212. FIG. 4B illustrates the table 200 after the top piece 228 has been inserted into the cavity 218 into a recessed position. As shown, the top surface 230 of the top piece 228 may be generally flush with the base 212 while in the inserted position in order to give the appearance of a finished table (e.g., a table with a non-removable top piece), for example. FIG. 4C shows the operation of the table 200 during the removal of the top piece 228. As the piston 226 is moved in the direction indicated by arrow 227, the piston 226 contacts and lifts the top piece 228 out of the cavity 218 into a dislodged position. As is to be appreciated, a user may use one hand to translate the piston 226 and their other hand to grasp the top piece 228 as it is lifted out of the cavity 218. In some embodiments, the user may flip the top piece 228 to reveal the bottom surface 232 and reinsert the top piece 228 into the cavity 218. In other embodiments, the user may wish to replace the top piece 228 with a second top piece that has a different design or pattern, for example. For example, a first top piece may have designs targeted at toddlers, while a second top piece may have designs targeted toward elementary students. All such embodiments are intended to be covered by this disclosure. Furthermore, while a piston 226 is illustrated in FIGS. 4A, 4B, and 4C, it is to be appreciated that in some embodiments the piston 226 may not be used. Instead, the user's hand functions as the piston when the user exerts force on the top piece 228 through the bore 220.

FIG. 5 shows an enlarged cross-sectional view of the table in FIG. 4B. The base 212 comprises a sidewall 236. The top piece 228 comprises an edge 238 that generally spans the top surface 230 and the bottom surface 232 of the top piece 228. When the top piece 228 is inserted into the cavity 218 (FIG. 4A), the edge 238 of the top piece 228 is proximate to the sidewall 236 of the base. The distance d₁ between the sidewall 236 and at 238 may be a relatively small distance. In some embodiments, for example, the distance d₁ is less than about 5 mm. In some embodiments, for example, the distance d₁ is less than about 2 mm. In some embodiments, for example, the distance d₁ is less than about 1 mm. In any event, the distance d₁ may be generally small enough such that a user's finger can not be used to readily remove the top piece 228 from the cavity 218. Furthermore, the base 212 may have a rim surface 213. The top surface 230 of the top piece may be substantially aligned with the rim surface 213 when the top piece 228 is inserted into the cavity. In some embodiments, the top surface 230 may extend beyond the rim surface 213. As illustrated, the top surface 230 may also be positioned below the rim surface 213 by a distance d₂. The distance d₂ may be in the range of about 0.0 to 1 cm, for example. As is to be appreciated, the magnitude of distance d₂ may be determined based on the desired aesthetics of the assembled table 200.

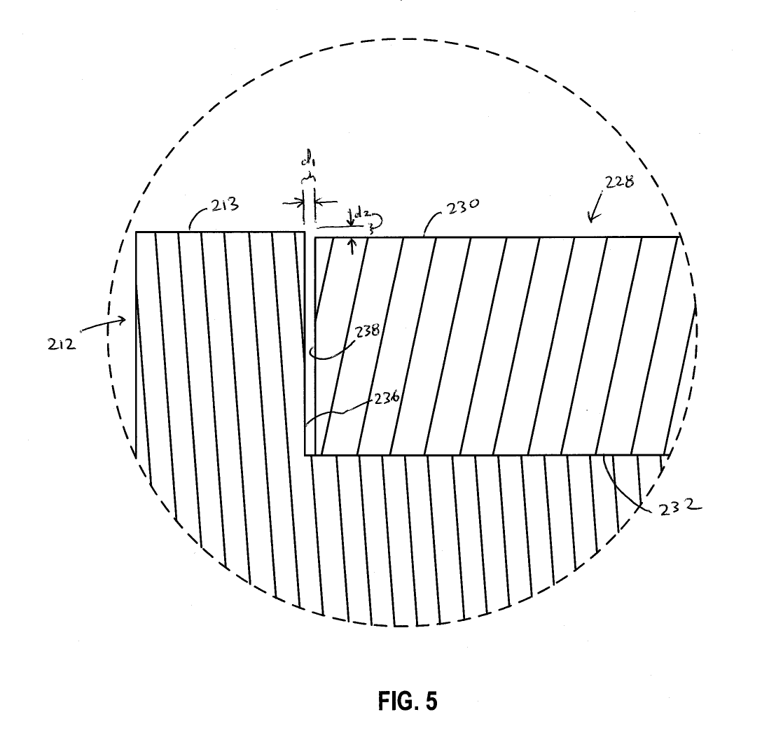

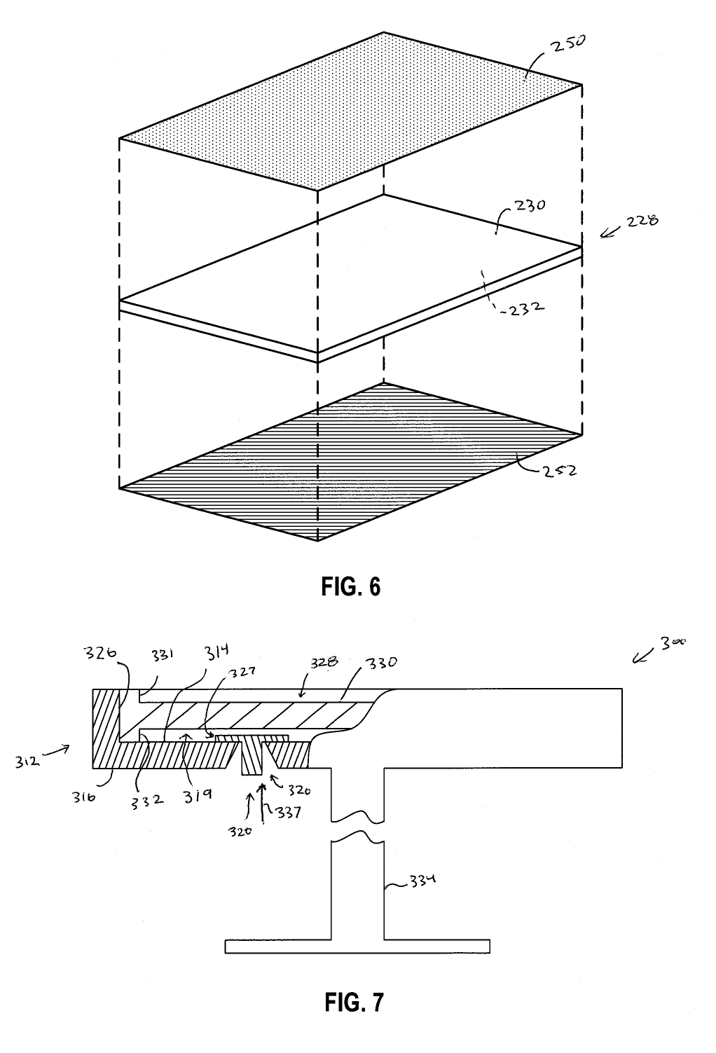

FIG. 6 is an exploded view of the top piece 228 in accordance with one non-limiting embodiment. The top piece 228 may be made from any suitable material, such as wood, plastic, foam, hardboard, cork, or particle board, for example. While the illustrated top piece 228 is rectangular, it may be have any desired shape or configuration. The top piece 228 may be substantially rigid or, in some embodiments, the top piece 228 may be flexible and/or malleable. The thickness of the top piece 228 may be, for example, about 3 cm. In some embodiments the thickness of the top piece 228 may be more or less than 3 cm. The top surface 230 may comprise a first print 250. The first print 250 may be adhered or otherwise coupled to the top surface 230 using any suitable technique. In one embodiment, glue or other suitable adhesive is used to adhere the first print 250 to the top surface 230. Similarly, the bottom surface 230 may comprise a second print 252. As is to be appreciated, the first print 250 may be different from the second print 252 such that the user may determine the aesthetics or the function of the table by choosing which surface of the top piece 228 to expose to observers. Furthermore, while the first print 250 and the second print 252 are shown as discrete elements in FIG. 6, it is to be appreciated that in some embodiments a wrapping technique may be used to apply a single sheet of prints to the top piece 228. Additionally, in some embodiments, the top piece 228 may comprise a design that is painted directly onto the top surface 230 and/or the bottom surface 232. In some embodiments, the top piece 228 may include colors, designs, or motifs that are coordinated with the design of the room within which the table is displayed. The top piece 228 may comprise, for example, geometric designs, educational designs, gaming designs, advertising material, or a variety of other suitable graphics. In one embodiment, at least one of the first print 1250 and/or the second print 1252 are a printable paper, such as a printable synthetic paper provided by YUPO, of Chesapeake, Va.

FIG. 7 is a partial cross-sectional elevational view of a pedestal table 300 in accordance with one non-limiting embodiment. Similar to previously described embodiments, a base 312 of the table 300 defines a cavity 319. The pedestal table 300 may be used in a restaurant setting, for example. A bore 320 is positioned through the base 312 and receives a piston 326. The piston 326 comprises a lifting portion 327 that sits on the receiving surface 314 of the base 312 in a first position. The top piece 328 comprises a first rim 331 and a second rim 332. When inserted into the cavity 318, the first rim 331 and the second rim 332 may be proximate to a sidewall 326 of the base 312. The top piece 328 may comprise a top surface 330 and a bottom surface 332. In a first position, as illustrated in FIG. 7, the lifting portion 327 may be disengaged from the top piece 328. As the piston 326 is moved in the direction indicated by arrow 337, the lifting portion 327 may engage the bottom surface 332 of the top piece 328 to lift the top piece 328 out of the cavity 319.

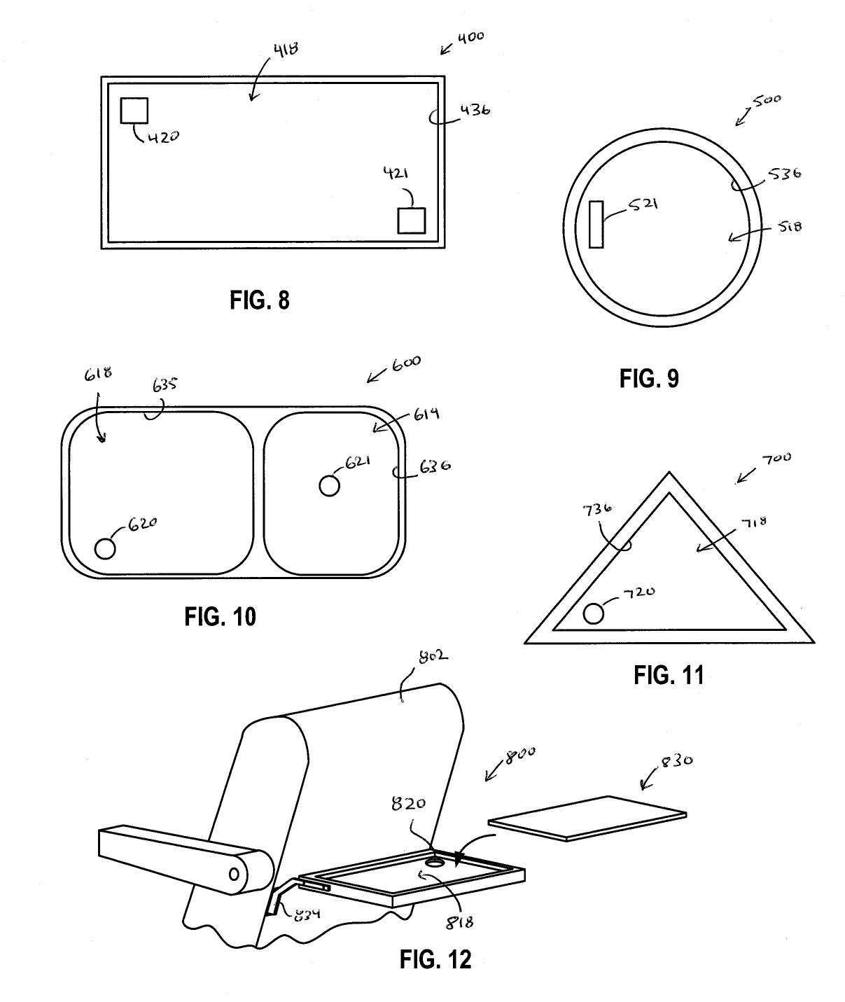

FIGS. 8 through 12 illustrate tables having removable top pieces in accordance with various embodiments. Referring first to FIG. 8, a table 400 is illustrated having a rectangular cavity 418 defined at least in part by a sidewall 436. The table 400 also comprises a first bore 420 and a second bore 421. As illustrated, the bores 420, 421 have a generally square cross-sectional profile. FIG. 9 illustrates a circular table 500 having a sidewall 536 that defines a cavity 518. In this embodiment, a bore 521 is positioned proximate the sidewall 536 and has a rectangular cross-sectional profile. Referring now to FIG. 10, a table 600 comprises a plurality of cavities. A first cavity 618 is defined by a sidewall 635 and comprises a bore 620. A second cavity 619 is defined by sidewall 636 and comprises a bore 621. In some embodiments, the table 600 may be used as a gaming table, for example. The first cavity 618 may hold a top piece with graphics directed to a first game while the second cavity 619 holds a top piece with graphics directed to a second game. FIG. 11, illustrates a triangular table 700 which comprises a cavity 718 defined by sidewall 736. The table 700 has a bore 720 with a circular cross-sectional shape. As is to be appreciated, the removable top piece may be used in a variety of implementations. FIG. 12, for example, illustrates a table 800 used in connection with an airline seat 802. The table 800 may be retractable and have at least one leg 834 connecting the table to the airline seat 802. The table 800 may define a cavity 818 that is dimensioned to receive a top piece 830. Furthermore, the table 800 may comprise a bore 820 for receiving a piston to allow the disassembly of the table 800. As is to be appreciated, the top piece 830 may comprise a variety of graphics, for example, that may be viewed during a flight. One embodiment, the top piece 830 comprises at least one writable surface that may be used by children during a flight. In various embodiments, pistons may be use to dislodge a top pieces from the tables. In other embodiments, the user may access the top piece via the bores with their hands.

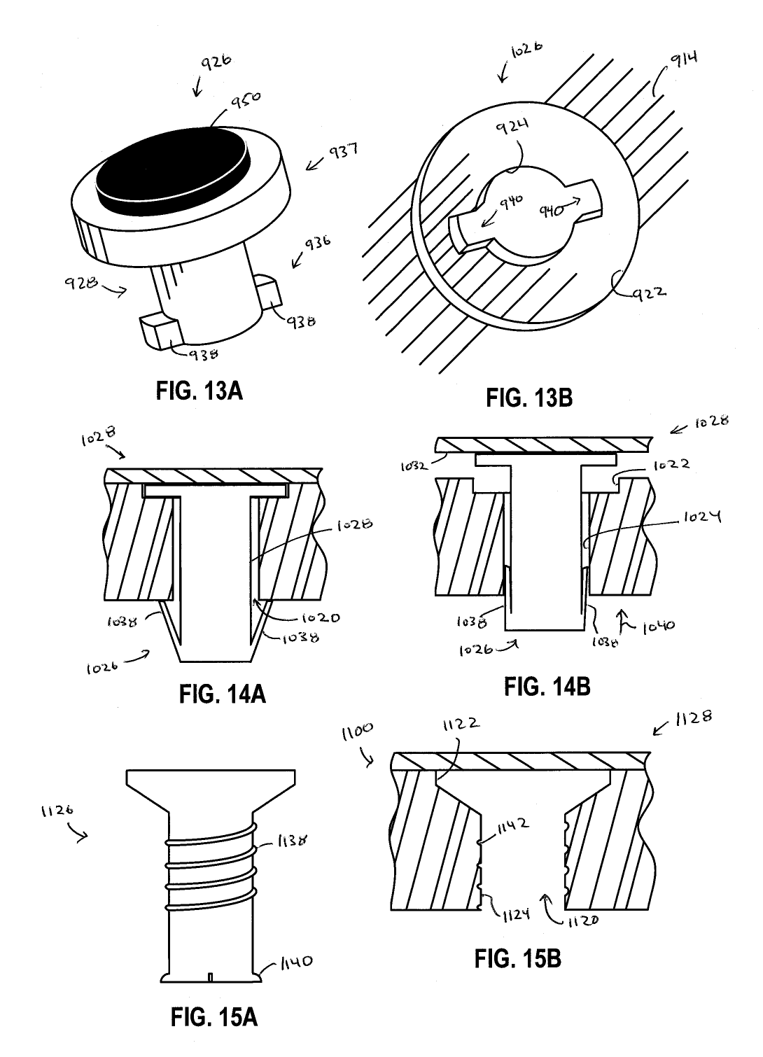

FIG. 13A is a perspective view of a piston 926 in accordance with one non-limiting embodiment. The piston 926 comprises a lifting portion 937 coupled to a body portion 928. As illustrated, the lifting portion 937 may comprise a non-marring element 950. As is to be appreciated, the non-marring element 950 may be any suitable material such as, rubber, nylon, or plastic, for example. The non-marring element 950 may be configured to reduce the likelihood of damaging the top piece when using the piston 926 to remove the top piece from a table. As illustrated, the piston 926 may comprise an interlock 936. The interlock 936 generally prohibits the piston from translating through a bore until a condition has been met. The interlock 936 may be used, for example, to prohibit a child from operating the piston 926. As illustrated, the interlock 926 comprises a plurality of outwardly extending tabs 938 which radially extend from the body portion 928. While two outwardly extending tabs 938 are illustrated, it is to be appreciated that any suitable number of outwardly extending tabs may be used. FIG. 13B shows a bore 1026 that is configured to receive the piston 926. The bore 926 comprises a first diameter 922 that is larger then a second diameter 924. The first diameter 922 is positioned on the receiving surface 914. As shown in FIG. 13B, the bore 1026 may comprise a plurality of notches 924 that are configured to receive the outwardly extending tabs 938 of the piston 926. Accordingly, the piston 926 must be rotated by the user in order to align the outwardly extending tabs 938 with the notches 940 before the piston 926 is permitted to translate through the bore 1026.

FIG. 14A and FIG. 14B illustrate a piston 1026 in a first and second position, respectively. The piston 1026 comprises tabs 1038 extending from a piston body 1028. The tabs 1038 may be flexible such that a user may squeeze the tabs toward the piston body 1028. The tabs 1038 may be biased towards an extended position to keep the piston 1026 from translating through the bore 1020 and engaging the top piece 1028. When the user squeezes the tabs 1038 towards the piston body 1028, the outer diameter of the lower portion of the piston 1026 is reduced thereby allowing the piston 1026 to translate within the bore 1020 in the direction indicated by arrow 1040. As the piston 1028 is moved in direction 1040, the top piece 1028 may be lifted to aid in the removal of the top piece 1028 from the associated table. As illustrated, the top piece 1028 may have a top surface 1030 and a bottom surface 1032. The piston 1026 may contact the bottom surface 1032 as the piston 1026 is moved from the first position to the second position. Furthermore, the bore 1020 may also comprise a first diameter 1022 and a second diameter 1024, where the second diameter 1024 is less than the first diameter 1022.

FIG. 15A shows an embodiment of a piston 1126 comprising threads 1138. The piston 1126 may also comprise at least one wing 1140 to aid the user in rotating the piston 1126 when used to remove a top piece 1128 from a table. FIG. 15B is a cross-sectional view of a table 1100 with the piston removed for clarity. As illustrated, the table 1100 comprises a bore 1120 with threads 1142 that are configured to receive the threads 1138 of the piston 1126. The bore 1120 comprises a first diameter 1122 proximate the top piece 1128 and a second diameter 1124. In some embodiments, the first diameter 1122 may be substantially equal to the second diameter 1124.

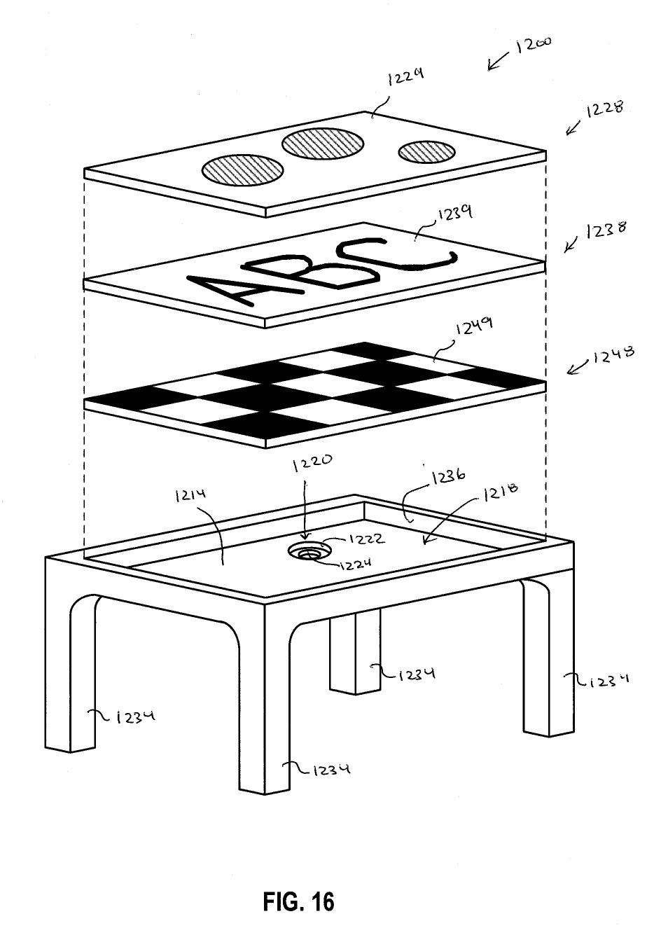

FIG. 16 illustrates an exploded perspective view of a table 1200 in accordance with one non-limiting embodiment. The table 1200 comprises a base 1212 from which legs 1234 extend. The base 1212 also comprises a sidewall 1236 and a receiving surface 1214. Collectively, the receiving surface 1214 and the sidewall 1236 define a cavity 1218. The receiving surface 1214 also defines a bore 1220 which comprises a first diameter 1222 and a second diameter 1224. While the bore 1220 is illustrated at being circular, it is to be appreciated that any suitable cross-sectional shape may be used. The table 1200 also comprises a plurality of top pieces. As illustrated, the table 1200 comprises a first top piece 1228, a second top piece 1238 and a third top piece 1248. The first top piece 1228 comprises a top surface 1229. The top surface 1229 may comprise, for example, a geometric print. The second top piece surface 1238 comprises a top surface 1239. The top surface 1239 may comprise, for example, educational-type graphics. The third top piece 1248 comprises a top surface 1249. The top surface 1249 may comprise, for example, a gaming surface. As is to be appreciated, each of the first, second and third top pieces 1228, 1238, and 1240 may each have a graphic on the bottom surfaces as well. Furthermore, one or more of the first, second and third top pieces 1228, 1238, 1248 may be magnetic and/or have a writable/erasable surface. In one embodiment, all three top pieces may be received into the cavity 1218. The user of the table may then selectively decide which order to place the top pieces into the cavity 1218. Therefore, the user may select, for example, a gaming surface, an educational surface, or an aesthetically pleasing surface to display to observers. A piston (not illustrated) may be positioned within the bore 1220 in aid in the removal of the first, second and third top pieces 1228, 1238, 1248, similar to previously described embodiments. Furthermore, the piston may comprise an interlock to impede unwanted translation of the piston through the bore 1220.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments. The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”. Additionally, it will be appreciated that for conciseness and clarity, spatial terms such as “vertical,” “horizontal,” “up,” and “down” may be used herein with respect to the illustrated embodiments. However, the devices described herein may be used in many orientations and positions, and these terms are not intended to be limiting and absolute.

We claim:

1. An table apparatus, comprising:
a base comprising:
a receiving surface, an underside surface, and at least one sidewall coupled to the receiving surface;
a cavity defined at least in part by the receiving surface and the at least one sidewall; and
a bore extending through the receiving surface and the underside surface, wherein the bore has a first diameter at the receiving surface and a second diameter at the underside surface;
a piston comprising a lifting portion, the piston positionable at least partially within the bore, the piston movable between a first position and a second position when positioned at least partially within the bore;
a top piece dimensioned to be at least partially received by the cavity, the top piece having a top surface and a bottom surface, the piston not lifting the top piece out of the cavity in the first position, and the lifting portion of the piston contacting the bottom surface and lifting the top piece at least partially out of the cavity in the second position; and
at least one leg extending from base.

2. The table apparatus of claim 1, wherein the top piece comprises an edge connecting the top surface to the bottom surface, and wherein the when the top piece is at least partially received by the cavity, at least a portion of the edge is separated from at least a portion of the sidewall by a distance, wherein the distance is less than about 2 mm.

3. The table apparatus of claim 1, wherein the first diameter is greater than the second diameter.

4. The table apparatus of claim 3, wherein base comprises a shoulder positioned within the bore, and wherein the shoulder defines an opening having a diameter.

5. The table apparatus of claim 4, wherein the outer diameter of the lifting portion is greater than the diameter of the opening.

6. The table apparatus of claim 1, wherein the cross-sectional shape of the bore is selected from the group consisting of circular, square, oblong, and asymmetrical.

7. The table apparatus of claim 1, wherein the piston extends beyond the underside surface when the piston is in the first position.

8. The table apparatus of claim 1, wherein the top piece comprises a first print coupled to the top surface and a second print coupled to the bottom surface.

9. The table apparatus of claim 1, wherein at least one of the top surface and the bottom surface comprises a magnetic surface.

10. The table apparatus of claim 1, wherein the piston comprises an interlock.

11. The table apparatus of claim 10, wherein the piston comprises an outwardly extending tab and the bore in the underside surface comprises a notch dimensioned to receive the outwardly extending tab.

12. The table apparatus of claim 1, wherein at least a portion of the piston comprises threads and an interior wall of the bore comprises corresponding threads.

13. An table apparatus, comprising:
a base comprising:
a receiving surface, an underside surface, and at least one sidewall coupled to the receiving surface;
a cavity defined at least in part by the receiving surface and the at least one sidewall, the cavity configured to receive a top piece; and
a bore extending through the receiving surface and the underside surface;
a piston comprising a lifting portion, the piston positionable at least partially within the bore, the piston movable between a first position and a second position when positioned at least partially within the bore; and
at least one leg extending from base.

14. The table apparatus of claim 13, comprising:
a top piece dimensioned to be at least partially received by the cavity, the top piece having a top surface and a bottom surface, the piston not lifting the top piece out of the cavity in the first position, and the lifting portion of the piston contacting the bottom surface and lifting the top piece at least partially out of the cavity in the second position.

15. The table apparatus of claim 14, wherein the top piece comprises an edge connecting the top surface to the bottom surface, and wherein the when the top piece is at least partially received by the cavity, at least a portion of the edge is separated from at least a portion of the sidewall by a distance, wherein the distance is less than about 2 mm.

16. The table apparatus of claim 14, wherein one of the top surface and the bottom surface comprises one of a magnetic surface and an erasable surface.

17. The table apparatus of claim 14, wherein the top piece comprise as least one print adhered to one of the top and bottom surfaces.

18. The table apparatus of claim 13, wherein the lifting portion comprises a non-marring member.

19. The table apparatus of claim 13, wherein the bore comprises a first portion extending through the receiving surface and a second portion extending through the receiving surface, the first portion having a larger diameter than the diameter of the second portion.

20. The table apparatus of claim 19, wherein the piston comprises a first portion having a first maximum width and a second portion having a second maximum width, wherein the first maximum width is greater than the second maximum width, wherein the first maximum width is less than the diameter of the first portion of the bore, wherein the first maximum is greater than the diameter of the second portion of the bore, and wherein the second maximum width is less than the diameter of the second portion of the bore.

21. A method of table use, comprising:
inserting a top piece into a cavity of a base with a first surface exposed, the base having a bore extending from an underside of the base into the cavity, a piston positioned within the bore and supported by the base;
advancing the piston at least partially through the bore;
contacting a second surface of the top piece with the piston;
lifting the top piece from the cavity;
removing the top piece from the cavity;
inserting the top piece into the cavity of the base with the second surface exposed.

22. The method of table use of claim 21, wherein the top piece comprises a edge spanning the first surface and the second surface and the base comprises a sidewall, wherein inserting a top piece into a cavity of a base with a first surface exposed comprising positioning the edge within 2 mm of the sidewall.

23. The method of table use of claim 21, wherein advancing the piston at least partially through the bore comprises engaging an interlock member on the piston to allow translation of the piston through the bore.

24. A method of manufacturing a table, comprising:
forming a base, the base comprising a receiving surface, an underside surface, and at least one sidewall coupled to the receiving surface;
forming at least one leg attachable to the base.
forming a cavity defined at least in part by the receiving surface and the at least one sidewall;
forming a bore extending through the receiving surface and the underside surface;
positioning a piston at least partially into the bore, the piston comprising a lifting portion, the piston movable between a first position and a second position when positioned at least partially within the bore; and
positioning a top piece dimensioned to be at least partially received by the cavity into the cavity, the top piece having a top surface and a bottom surface, the bottom surface positioned to contact the piston during translation of the piston through the bore.

25. The method of manufacturing a table of claim 24, wherein forming the bore comprises forming a bore having a first portion and a second portion, wherein the maximum width of the first portion is greater than the maximum width of the second portion.

26. The method of manufacturing a table of claim 25, wherein positioning the piston comprises positioning the living portion proximate the first portion of the bore.

27. The method of manufacturing a table of claim 24, wherein forming the bore comprises forming a bevel within the bore to receive the lifting portion of the piston.

28. The method of manufacturing a table of claim 24, wherein the base is formed from one of wood and plastic.

29. An table apparatus, comprising:
a base comprising:
a receiving surface, an underside surface, and at least one sidewall coupled to the receiving surface;
a cavity defined at least in part by the receiving surface and the at least one sidewall; and
a bore extending through the receiving surface and the underside surface;
a top piece dimensioned to be at least partially received by the cavity, the top piece having a top surface and a bottom surface, the top piece moveable between a recessed position and a dislodged position; and
at least one leg extending from base.

30. The table apparatus of claim 29, comprising a piston comprising a lifting portion, the piston positionable at least partially within the bore, the piston movable between a first position and a second position when positioned at least partially within the bore.
